(19) United States
(12) Patent Application Publication
(10) Pub. No.: US 2019/0087023 A1
(43) Pub. Date: Mar. 21, 2019

(54) Mouse with Automatic DPI Regulation and Method Thereof

(71) Applicant: SHENZHEN EVISION SEMICONDUCTOR TECHNOLOGY CO., LTD., Shenzhen (CN)

(72) Inventor: Guangli Zhao, Shenzhen (CN)

(21) Appl. No.: 16/190,203

(22) Filed: Nov. 14, 2018

Related U.S. Application Data
(63) Continuation of application No. PCT/CN2016/082166, filed on May 16, 2016.

(51) Int. Cl. G06F 3/0354; G06F 3/038

(52) U.S. Cl. CPC G06F 3/03543; G06F 3/0383

(57) ABSTRACT

A mouse with automatic DPI regulation and method thereof, comprising a displacement module, an MCU and a DPI module. The displacement module is used for acquiring the displacement information of the mouse, and forming a cursor movement trajectory with the maximum displacement on the display according to the displacement information; the DPI module is used for recording an initial DPI value of the mouse as N, and regulating the DPI value thereof; and the MCU obtains the number of pixels corresponding to the cursor movement trajectory, records the number of pixels as M1, obtains the number of pixels of a diagonal line or a horizontal line of the display, and records the number of pixels as M2; and the MCU sets an optimal DPI value as M2/M1*N, controls and regulates the DPI module. This method solves the problems of manual regulation and optimal DPI configuration on different displays.

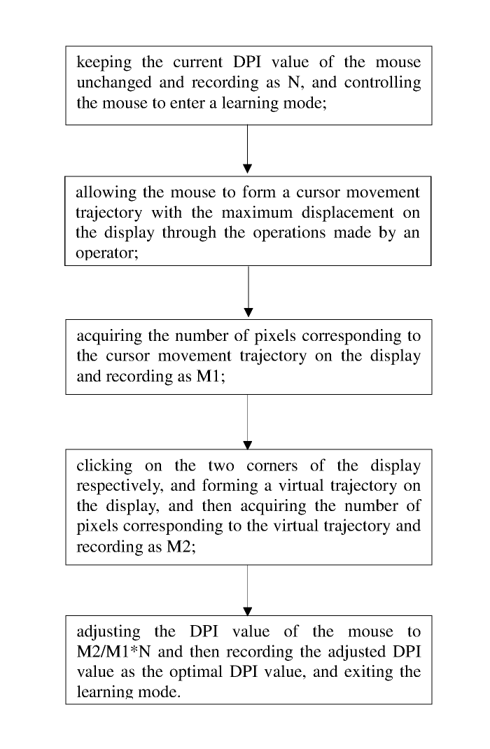

### CROSS REFERENCE TO RELATED APPLICATIONS

The present application is a Continuation Application of PCT application No. PCT/CN2016/082166 filed on May 16, 2016, the contents of which are hereby incorporated by reference.

### TECHNICAL FIELD

The invention relates to the technical field of mouse, in particular to a mouse with automatic DPI regulation and a method thereof.

### BACKGROUND

Existing mouse consists of a light emitting diode, a set of lens, an optical sensor and a control chip. The light emitted by the light emitting diode irradiates the desktop through the lens, is reflected by the desktop, and then irradiates the optical sensor through the lens. When the mouse moves, the optical sensor can sense the change of the image reflected by the desktop. The optical sensor is electrically connected to the control chip for transmitting the ever-changing light and shadow image signal to the control chip, which modulates the signal into a form that can be read by the computer processor, and outputs the signal to the computer to control the cursor movement on the display.

In most cases, users may select an appropriate DPI value (i.e., the number of pixels for every inch of mouse movement on the display) to operate the mouse based on the size of the display screen and its resolution (i.e., the pixels of the display screen). Depending on different optical sensors, the mouse products can be divided into 400 dpi, 800 dpi, 1600 dpi, 3200 dpi, 6400 dpi, etc. or 500 dpi, 1000 dpi, 2000 dpi, 4000 dpi, 8000 dpi, etc. to reflect its moving speed. However, due to the limited number of standard levels mentioned above, the mouse cannot accurately configure the most appropriate DPI value matching the size of the display screen for the operator; meanwhile, users have to manually select and regulate the mouse dpi level; and even if the level is selected, sometimes the level may be inevitably too large or small.

A Chinese invention patent (publication No.: CN101714035A) discloses a method for automatic DPI regulation of a mouse, in which the memory of mouse stores the corresponding relationship between the number of displacement coordinates obtained by the mouse imaging system in unit time and the mouse DPI value, and the microprocessor of mouse automatically changes the mouse DPI through the number of displacement coordinates obtained by the mouse imaging system in unit time, as detected in real time. The method comprises the following steps: A. the mouse imaging system obtains the number of mouse displacement coordinates in unit time in real time and transmits the number of coordinates to the microprocessor of mouse; B. the microprocessor of mouse calls for the corresponding relation through the value of the number of mouse displacement coordinates in unit time to obtain the corresponding mouse DPI value.

The disadvantage of the above-mentioned existing patent is that the mouse DPI value is set and saved based on the number of pixels moved per unit time, which does not involve any associated processing on the screen size and the using habits of the operator.

However, no optimal way has yet been found to solve the above problems, i.e. to solve the optimal DPI configuration on different displays based on the operators with different body types and using habits. The difficult point in solving the above problems lies in the DPI value level setting of the optical sensor in a mouse, in light of different sizes and definition of the display screen. Moreover, no mouse on the market has ever been intelligent and self-adaptive enough at present.

### SUMMARY OF THE INVENTION

The invention provides a mouse with automatic DPI regulation and a method thereof, which solve the problem of the optimal DPI configuration on different displays according to the operators with different body types and using habits in the prior art.

The technical scheme of the invention is realized as follows:

A mouse with automatic DPI regulation comprises a displacement module, an MCU and a DPI module;

The displacement module is used for forming a cursor movement trajectory with the maximum displacement on the display;

The DPI module is used for recording an initial DPI value of the mouse as N, and regulating the DPI value thereof;

The MCU obtains the number of pixels corresponding to the cursor movement trajectory, records the number of pixels as M1, obtains the number of pixels of a diagonal line or a horizontal line of the display, and records the number of pixels as M2; and the MCU sets an optimal DPI value as M2/M1*N, controls and regulates the DPI module.

Further, the mouse with automatic DPI regulation comprises a mode control module for controlling the mouse to enter a learning mode and switching the mode of the mouse.

Further, the mouse with automatic DPI regulation comprises a sensor module and a judgment module, wherein the sensor module is used for receiving the mouse displacement input information, converting the information into a digital signal corresponding to the displacement information, and forming a cursor movement trajectory with the maximum displacement on the display according to the digital signal; and

The judgment module is used for judging the DPI range required a mouse in use.

A method for automatic DPI regulation comprises the following steps:

step i, keeping the current DPI value of the mouse unchanged and recording as N, and controlling the mouse to enter a learning mode;

step ii, allowing the mouse to form a cursor movement trajectory with the maximum displacement on the display through the operation made by an operator;

step iii, acquiring the number of pixels corresponding to the cursor movement trajectory on the display and recording as M1;

step iv, clicking on the two corners of the display respectively, and forming a virtual trajectory connecting the two corners on the display, and then acquiring the number of pixels corresponding to the virtual trajectory and recording as M2;

step v, adjusting the DPI value of the mouse to M2/M1*N and then recording the adjusted DPI value as the optimal DPI value, and exiting the learning mode.

Further, if the cursor movement trajectory is arc-shaped in step ii, then step iv specifically comprises the following sub-steps:

sub-step i, calculating the radius value R corresponding to the cursor movement trajectory with the maximum displacement;

sub-step ii, clicking on the two corners of the display respectively, and forming a virtual trajectory with the radius value R on the display, and then acquiring the number of pixels corresponding to the virtual trajectory and recording as M2;

Further, if the cursor movement trajectory is line segment in step ii, then

step iv specifically comprises the following sub-steps: clicking on the two corners of the display respectively, and forming a virtual line segment trajectory connecting the two corners on the display, and then acquiring the number of pixels corresponding to the virtual line segment trajectory and recording as M2.

Further, the following steps are further required between step ii and step iii:

setting multiple levels for the DPI of the mouse; judging whether the cursor movement trajectory with the maximum displacement acquired by moving the mouse exceeds the screen range of the display; if so, the current DPI level of the mouse is greater than or equal to the optimal DPI value, reducing the DPI level or reducing the current DPI value by multiple, and then going to step i; if not, proceeding to step iii.

Further, the mouse is provided with an optical sensor and comprises an MCU connected to a host of the display. Step ii specifically comprises the following sub-steps: the user moves the mouse in the maximum range with the elbow joint as the center of a circle, the optical sensor sends the displacement information of the mouse to the MCU, the MCU sends a corresponding signal to the host, and the host controls a corresponding cursor movement trajectory with radius R on the display.

Further, the mouse is an AirMouse worn on the user's hand. Step ii specifically comprises the following sub-steps: the user moves the elbow joint and palm in the maximum range with the elbow joint as the center of a circle, and a corresponding cursor movement trajectory with the maximum displacement appears on the display.

Further, if the mouse is provided with a scroll ball, step ii specifically comprises the following sub-steps: the user moves the scroll ball in the maximum range; the scroll ball generates a square wave signal through an encoder connected thereto, and forms a corresponding cursor movement trajectory with the maximum displacement on the display according to the square wave signal.

The beneficial effects of the invention are as follows: the user operates the mouse to form a cursor movement trajectory with the maximum amplitude of movement on the display. The optimal DPI value is calculated according to the cursor movement trajectory and the number of pixels on the display, and the DPI value is regulated after a full consideration is given to the factors such as the user and the display, which solves the problems of manual adjustment and optimal DPI configuration on different displays based on the operators with different body types and using habits.

### BRIEF DESCRIPTION OF THE DRAWINGS

In order to clearly describe the embodiments of the invention or the technical scheme in the prior art, the embodiments or drawings in technical description will be simply introduced as follows. Apparently, the drawings described below are only some embodiments of the invention. Those of ordinary skill in the art can obtain other drawings based on these drawings without creative work.

The FIGURE is a flow chart of the method for automatic DPI regulation according to the invention.

### DETAILED DESCRIPTION OF THE PREFERRED EMBODIMENT

The technical scheme in the embodiments of the invention will be described clearly and completely as follows. Apparently, the embodiments described are only some embodiments of the invention, but not all embodiments. Based on the examples of the invention, all other examples obtained by those of ordinary skill in the art without creative work shall fall within the protection scope of the invention.

Memory Control Unit (MCU) is essentially a single chip microcomputer, which is a chip-level computer formed by integrating the CPU, RAM, ROM, timing counter and various I/O interfaces on a single chip.

“AirMouse” is a device that controls cursor movement through the spatial displacement of the mouse, and its expedience lies in that a desktop may not be provided, which will make the operator a better body feeling, especially in the game.

The invention provides a mouse with automatic DPI regulation, comprising a displacement module, an MCU and a DPI module.

The displacement module is used for forming a cursor movement trajectory with the maximum displacement on the display. Forming a cursor movement trajectory with the maximum displacement for the purpose of regulating the DPI of the mouse means that the user moves the mouse on the desktop or mouse pad according to the most usual way (or most comfortable movement), for example, taking the elbow joint as the center of a circle, the user moves the mouse on the desktop or mouse pad from the leftmost to the rightmost or from the rightmost to the leftmost within the maximum amplitude of movement according to the best practice of using the mouse or the most comfortable range of movement. The using habit of left-handers may be contrary to that of right-handers.

In other embodiments, the user moves the mouse from the leftmost to the rightmost, or from the rightmost to the leftmost within the maximum amplitude of movement by taking the wrist as the center of a circle. Some users are used to putting their arms on the desktop when they use the mouse. In this case, they only move the mouse with the movement of their wrists. Therefore, moving a mouse with the wrist as the center of a circle also belongs to the protection scope of the invention.

The displacement module can acquire the displacement information through an optical sensor or a position sensor.

In other embodiments, the displacement module is a mouse pad matching the mouse, and the mouse pad is divided into a plane coordinate system consisting of X-axis and Y-axis. On the mouse pad, the maximum movement range of the mouse is also limited to the maximum movement trajectory of the cursor corresponding to the range of the mouse pad.

The DPI module is used for recording an initial DPI value of the mouse as N, and regulating the DPI value thereof. The initial DPI value of the mouse is the value of one of several levels of the mouse itself. DPI levels include one or more of 400 dpi, 800 dpi, 1600 dpi, 3200 dpi, 6400 dpi or 500 dpi, 1000 dpi, 2000 dpi, 4000 dpi, 8000 dpi. The DPI module can be regulated by a physical shift switch or a software-controlled program.

The MCU obtains the number of pixels corresponding to the cursor movement trajectory, records the number of pixels as M1, obtains the number of pixels of a diagonal line or a horizontal line of the display, and records the number of pixels as M2; and the MCU sets the optimal DPI value as M2/M1*N, controls and regulates the DPI module. The MCU has a built-in program to regulate the DPI value. When it obtains the required parameter value, it can automatically regulate the DPI value of the mouse.

The mouse of the invention further comprises a mode control module for controlling the mouse to enter a learning mode and switching the mode of the mouse. In the learning mode, the user moves the mouse within the maximum displacement by taking the elbow joint as the center of a circle, so as to form a cursor movement trajectory with the maximum displacement on the display, obtains the number of pixels corresponding to the cursor movement trajectory on the display and records the number of pixels as M1, clicks on the two corners of the display to a virtual trajectory on the display, then acquires the number of pixels corresponding to the virtual trajectory and records the number of pixels as M2, adjusts the DPI value of the mouse to M2/M1*N and records the adjusted value as the optimal DPI value, and then exits the learning mode.

In other embodiments, the invention also includes a judgment module for judging the DPI range required for mouse in use.

In different cases, the user requires different DPI values of the mouse; for example, when playing games, the user may need to use a mouse with very high sensitivity; when drawing a picture, the user may need to use a mouse with lower sensitivity.

Therefore, the judgment module can be used for judging whether the user needs to play games or draw pictures next, so as to set the mouse in a relatively appropriate DPI level. Then, the user operates the mouse to form a cursor movement trajectory with the maximum displacement on the display, and obtains the values of M1 and M2.

In other embodiments, the invention further comprises a sensor module for receiving the user input information, converting the information into a digital signal corresponding to the displacement information, and forming a cursor movement trajectory with the maximum displacement on the display according to the digital signal.

In the existing optical mouse, an LED lamp is arranged at the bottom, and the light is directed at the desktop through a lens at a certain angle to irradiate the shadow generated by the rough surface, then fed back to the sensor by the lens through plane refraction to enter the optical engine, and finally reflected on the movement of the cursor on the display.

However, a mouse may generate the corresponding square wave by, for example, turning the scroll ball on the mouse, and the cursor on the display will result in the corresponding trajectory and movements.

The movement of the cursor on the display is controlled by, for example, finger pressing, receiving a signal from a pressure sensor, and controlling the pressing direction and force.

All of the above mouse products can adjust the DPI values through the algorithm of the invention.

As shown in the FIGURE, the invention further provides a method for automatic DPI regulation, which specifically comprises the following steps:

step i, keeping the current DPI value of the mouse unchanged and recording as N, and controlling the mouse to enter a learning mode;

step ii, allowing the mouse to form a cursor movement trajectory with the maximum displacement on the display through the operations made by an operator;

Forming a cursor movement trajectory with the maximum displacement means that the user moves the mouse on mouse pad according to the most usual way (or most comfortable movement), for example, taking the elbow joint as the center of a circle, moves the mouse on mouse pad from the leftmost to the rightmost or from the rightmost to the leftmost within the maximum amplitude of movement according to the best practice of using the mouse or the most comfortable range of movement. The using habit of left-handers may be contrary to that of right-handers.

In other embodiments, the user moves the mouse from the leftmost to the rightmost, or from the rightmost to the leftmost within the maximum amplitude of movement by taking the wrist as the center of a circle. Some users are used to putting their arms on the desktop when they use the mouse. In this case, they only move the mouse with the movement of their wrists. Therefore, moving the mouse with the wrist as the center of a circle also belongs to the protection scope of the invention.

step iii, acquiring the number of pixels corresponding to the cursor movement trajectory on the display in step ii and recording as M1;

step iv, clicking on the two opposite corners or any two corners of the display respectively, and forming a virtual trajectory on the display, and then acquiring the number of pixels corresponding to the virtual trajectory and recording as M2;

step v, adjusting the DPI value of the mouse to M2/M1*N and then recording the adjusted DPI value as the optimal DPI value, and exiting the learning mode.

The following steps are also included before step i:

Setting multiple levels for the DPI of the mouse. The DPI levels include one or more of 400 dpi, 800 dpi, 1600 dpi, 3200 dpi, 6400 dpi or 500 dpi, 1000 dpi, 2000 dpi, 4000 dpi and 8000 dpi, and the mouse is provided with a DPI switching device for adjusting the DPI level.

If the cursor movement trajectory is arc-shaped in step ii, then step iv specifically comprises the following sub-steps:

sub-step i, calculating the radius value R corresponding to the cursor movement trajectory;

sub-step ii, clicking on the two corners of the display respectively, and forming a virtual trajectory with the radius value R on the display, and then acquiring the number of pixels corresponding to the virtual trajectory and recording as M2;

In step ii, the cursor movement trajectory is set as a line segment. If the horizontal line segment of the display is used, step iv specifically comprises the following sub-steps:

clicking on the two corners of the display respectively, and forming a virtual trajectory connecting the two corners on the display, and then acquiring the number of pixels corresponding to the virtual trajectory and recording as M2.

If the cursor movement trajectory is a diagonal line segment, step iv specifically comprises the following sub-steps: clicking on the two opposite corners of the display respectively, and forming a virtual trajectory connecting the two corners on the display, and then acquiring the number of pixels corresponding to the virtual trajectory and recording as M2;

In step ii, if the cursor movement trajectory is beyond the screen range of the display, that is, the current DPI level of the mouse is greater than or equal to the optimal DPI value, the DPI level is reduced or current DPI value is halved and recorded as N.

If the mouse is provided with an optical sensor and comprises an MCU connected to a host of the display, step ii specifically comprises the following sub-steps: the user moves the mouse in the maximum range with the elbow joint as the center of a circle, the optical sensor sends the displacement information of the mouse to the MCU, the MCU sends a corresponding signal to the host, and the host controls a corresponding cursor movement trajectory on the display.

If the mouse is an AirMouse worn on the user's hand, step ii specifically comprises the following sub-steps: the user moves the elbow joint and palm in the maximum range with the elbow joint as the center of a circle, and a corresponding cursor movement trajectory with the maximum displacement appears on the display.

If the mouse is a mechanical mouse with a scroll ball, step ii specifically comprises the following sub-steps: the user moves the scroll ball in the maximum range; the scroll ball generates a square wave signal through an encoder connected thereto, and forms a corresponding cursor movement trajectory with the maximum displacement on the display according to the square wave signal. If the optical sensor is used, the method is the same as that of the mouse on the desktop.

The invention has the functions and convenience that are not owned by the existing products on the market. Faster mouse speed is required with increasingly large display screen and increasingly high resolution; especially with the popularity of competitive games, standard DPI value of the optical sensor for mouse on the market correspondingly becomes higher, and the display screen becomes larger. But when the screen size gap of the display on the market becomes too large, the DPI level fixed by the optical sensor for mouse is difficult to meet the requirements of screen size and pixel level. Especially since the game players keep their usual relevant game configurations in the mouse they use, they often use their own mouse with other computers. However, the display screen may be different in size from previous computer, which requires the user to regulate the DPI level of the mouse corresponding to the display screen. Due to the limited standard level of the optical sensor, it is likely that the mouse does not have the best level value suitable for this display and can only be used with similar levels. The invention has the advantages that the mouse can be configured with non-grade DPI values, thus solving the problem that the user cannot configure the optimally matched DPI values.

In the invention, the mouse is optimally configured in combination with the size of the display screen and the length of the operator's arm. For these who are required to operate a mouse for a long time, especially for game players, the workload of their hands necessary for completing the same task is thus reduced as they can use the mouse more freely. The reason is that the optimization of DPI setting is combined with the most suitable habit of the operator and the length of his arm, so that the maximum movement range of the mouse at one time coincides with the maximum movement distance of the cursor on the display screen at one time. When the mouse moves from any position on the display screen to any other position, it must move once in one direction. Likewise, the maximum movement range of the mouse made by the operator on the display screen in the most habitual and comfortable way coincides with the required maximum movement distance, so as not to reduce the positioning accuracy when DPI setting is too large. Moreover, when the user operates a mouse, any hand shaking and small position perception may not be avoided. The invention minimizes the requirements on the user for controlling a mouse and also reduces fatigue and movement injury on the user in an intense game.

The invention is simple and convenient in DPI configuration, and the MCU can calculate the optimal DPI configuration value through the built-in software algorithm only by marking the full range according to the user's habit and physical characteristics and clicking on the farthest relative distance point on the input display screen.

The above mentioned embodiments are only preferred embodiments of the invention and not intended to limit the invention. Any modification, equivalent replacement and improvement made within the range of the spirit and rule of the invention shall be incorporated in the protection range of the invention.

1. A mouse with automatic DPI regulation, comprising a displacement module, an MCU and a DPI module;
the displacement module is used for forming a cursor movement trajectory with the maximum displacement on the display;
the DPI module is used for recording an initial DPI value of the mouse as N, and regulating the DPI value thereof; and
the MCU obtains the number of pixels corresponding to the cursor movement trajectory, records the number of pixels as M1, obtains the number of pixels of a diagonal line or a horizontal line of the display, and records the number of pixels as M2; and the MCU sets an optimal DPI value as M2/M1*N, controls and regulates the DPI module.

2. The mouse with automatic DPI regulation of claim 1, further comprising a mode control module for controlling the mouse to enter a learning mode and switching the mode of the mouse.

3. The mouse with automatic DPI regulation of claim 1, further comprising a sensor module and a judgment module, the sensor module is used for receiving the mouse displacement input information, converting the information into a digital signal corresponding to the displacement information, and forming a cursor movement trajectory with the maximum displacement on the display according to the digital signal; and
the judgment module is used for judging the DPI range required for a mouse in use.

4. A method for automatic DPI regulation, comprising the following steps:
step i, keeping the current DPI value of the mouse unchanged and recording as N, and controlling the mouse to enter a learning mode;
step ii, allowing the mouse to form a cursor movement trajectory with the maximum displacement on the display through operations made by an operator;
step iii, acquiring the number of pixels corresponding to the cursor movement trajectory on the display and recording as M1;
step iv, clicking on two corners of the display respectively, and forming a virtual trajectory connecting the two corners on the display, and then acquiring the number of pixels corresponding to the virtual trajectory and recording as M2;
step v, adjusting the DPI value of the mouse to M2/M1*N and then recording the adjusted DPI value as the optimal DPI value, and exiting the learning mode.

5. The method for automatic DPI regulation of claim 4, wherein, if the cursor movement trajectory is arc-shaped in step ii, then step iv specifically comprises the following sub-steps:
sub-step i, calculating the radius value R corresponding to the cursor movement trajectory with the maximum displacement;
sub-step ii, clicking on two opposite corners of the display respectively, and forming a virtual trajectory with the radius value R on the display, and then acquiring the number of pixels corresponding to the virtual trajectory and recording as M2;

6. The method for automatic DPI regulation according to claim 4, wherein, if the cursor movement trajectory is line segment in step ii, then
step iv comprises the following sub-steps: clicking on the two corners of the display respectively, and forming a virtual line segment trajectory connecting the two corners on the display, and then acquiring the number of pixels corresponding to the virtual line segment trajectory and recording as M2.

7. The method for automatic DPI regulation of claim 4, wherein the following steps are further required between step i and step iii:
setting multiple levels for the DPI of a mouse; judging whether the cursor movement trajectory with the maximum displacement acquired by moving the mouse exceeds the screen range of the display; if so, the current DPI level of the mouse is greater than or equal to the optimal DPI value, reducing the DPI level or reducing the current DPI value by multiple, and then going to step i; if not, proceeding to step iii.

8. The method for automatic DPI regulation of claim 4, wherein, the mouse is provided with an optical sensor and comprises an MCU connected to a host of the display; the step ii comprises the following sub-steps: the user moves the mouse in the maximum range with the elbow joint as the center of a circle, the optical sensor sends the displacement information of the mouse to the MCU, the MCU sends a corresponding signal to the host, and the host controls a corresponding cursor movement trajectory with radius R on the display.

9. The method for automatic DPI regulation of claim 4, wherein, the mouse is an AirMouse worn on the user's hand; the step ii comprises the following sub-steps: the user moves the elbow joint and palm in the maximum range with the elbow joint as the center of a circle, and a corresponding cursor movement trajectory with the maximum displacement appears on the display.

10. The method for automatic DPI regulation according to claim 4, wherein, if the mouse is provided with a scroll ball, the step ii comprises the following sub-steps: the user moves the scroll ball in the maximum range; the scroll ball generates a square wave signal through an encoder connected thereto, and forms a corresponding cursor movement trajectory with the maximum displacement on the display according to the square wave signal.
